(19) United States
(12) Patent Application Publication
(10) Pub. No.: US 2004/0096104 A1
(43) Pub. Date: May 20, 2004

(54) Method of color correction

(75) Inventor: Vladislav Terekhov, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co.., Ltd., Suwon-city (KR)

(21) Appl. No.: 10/627,972

(22) Filed: Jul. 28, 2003

(30) Foreign Application Priority Data
Jul. 30, 2002 (KR) 2002-44865

(51) Int. Cl. H04N 1/60

(52) U.S. Cl. 382/167; 358/518

(57) ABSTRACT

A color correction method includes producing a device gamut boundary surface, performing a gamut mapping process, and performing a color inverse transformation process. The device gamut boundary surface in a device independent color space is defined by a set of gamut descriptors. A gamut mapping direction is determined in consideration of the size of a gamut to be mapped. A target color space value and a source color space value are expressed in a device dependent color space. A color inverse transformation is provided by using linear interpolation in a triangle in a two-dimensional space. Triangles are formed by a Delaunay triangulation algorithm.

### CROSS REFERENCE TO RELATED APPLICATIONS

This application claims the benefit of Korean Patent Application No. 2002-44865, filed Jul. 30, 2002, in the Korean Intellectual Property Office, the disclosure of which is incorporated herein by reference.

### BACKGROUND OF THE INVENTION

1. Field of the Invention

The present invention relates to data processing technology and a color transformation look-up table, and more particularly, to a data storage and interpolation method which is useful when converting from one spatial structure to another, such as from one color system to another.

2. Description of the Related Art

A color device such as a CRT (Cathode-Ray Tube), a scanner, or a printer uses three or four color channels for color generation. Color signals for CRTs or scanners are R (red), G (green), and B (blue) signals, while color signals for printers are C (cyan), M (magenta), Y (yellow) and K (black) signals. A color space using R, G, B or C, M, Y, K channels is called a device dependent color space (DDCS). The color values in a device independent color space (DICS) can be represented in a CIEL*a*b* color space. R, G, B values of a CRT or scanner are transformable into values in the CIEL*a*b* color space according to a standard of the CIE (Commission Internationale de I'Eclairage). C, M, Y, K color values are transformable in the CIEL*a*b* color space by measuring color patches using physical instruments.

FIG. 1 illustrates a simple example of a color correction apparatus. Color values of a first device 100 and a second color device 110 are represented in the CIEL*a*b* color space. A color look-up table (CLUT) production block 120 analyzes data from the first and second color devices 100 and 110 and produces a CLUT 130. The first and second color devices 100 and 110 use R, G and B (RGB) values. The CLUT 130 is used for transforming of the RGB values of the first device 100 into color values of the second device 110.

The RGB channels are typically integer values from 0 to 255. The range of colors is bounded by a color cube. FIG. 2A illustrates an example of the distribution of a color cube. In total, a color cube 200 possesses 16,777,216 respectively different combinations of code values or signals (256*256*256). Accordingly, a printer may produce 16,777,216 different colors. Each color produced by a printer may be measured by a physical instrument measuring a color patch produced from the printer to determine a color signal position in the standard CIEL*a*b* color space. The range occupied by the 16,777,216 points of the color cube is called a device gamut when the signals in the area are converted into signals in the CIEL*a*b* color space.

By definition, the device gamut defines all the colors in the CIEL*a*b* color space which can be produced by a device. However, it is almost impossible to measure 16,777,216 color patches in practice. In practice, a small number of color patches 27, 126, 729, or 4913 are measured. For convenience, signal values for these color patches are usually chosen to be lattice points, covering the full range of the cube. FIG. 2A illustrates distribution of a color cube 200 with respect to 125 lattice points in RGB color space. An RGB gamut 210 is also illustrated in FIG. 2B.

### SUMMARY OF THE INVENTION

The present invention provides a color look-up table (CLUT) production method providing a relationship between values in an RGB device dependent color space of a source color device and values in an RGB device dependent color space of a target color device.

The present invention also provides a method for defining and producing a gamut boundary by using a set of triangles or planes based on a color look-up table (CLUT) of given points.

The present invention also provides a method of determining a direction of a gamut mapping routine or a direction of points to be re-located.

The present invention also provides a fast color inverse interpolation method using a Delaunay triangulation algorithm.

The present invention also provides a method for truncating a gamut in any direction for a fast point-in-space test.

According to an aspect of the present invention, there is provided a method of color correction comprising selecting a gamut boundary signal from a gamut in a device independent color space (DICS); dividing the gamut into a set of triangles representing a gamut shape in the device independent color space (DICS); intersecting the gamut with a first predetermined number of planes which are perpendicular to an a*b* two-dimensional space and intersect with each other on an L* axis; dividing each plane by a second predetermined number of radial unit vectors; selecting each plane and each unit vector which are separated at a predetermined angle; and determining an intersection point between the gamut boundary and each selected unit vector, by using a ray-triangle-inclusion test.

The color correction method may further comprise defining a gamut mapping direction according to sizes of a source gamut and a reproduction gamut, in which the gamut mapping direction proceeds from a gamut having a smaller size to a gamut having a larger size. The first predetermined number may be 360. The second predetermined number may be 180.

According to an aspect of the present invention, there is provided a method of color correction after gamut mapping comprising regenerating a gamut shape in a device independent color space (DICS) into a predetermined structure represented in a three-dimensional space; intersecting the structure of the gamut shape represented in the three-dimensional space with planes; connecting respective points in a set of points created by intersection of the gamut shape with a plane; calculating a color value of each point; judging whether a structure formed of points to be color-inverse-transformed includes points generated by the gamut-plane intersection; and performing a color inverse transformation process by linear interpolation in the structure.

The regenerated gamut shape may be represented in the three-dimensional space by a set of tetrahedrons, cubes, pyramids, prisms, or lines.

The connecting of the respective points may be performed by using a Delaunay triangulation algorithm.

The calculating of the color value of each point may be performed using linear interpolation between vertexes of the structure of the gamut shape represented in the three-dimensional space.

The judging whether a structure formed of points to be color-inverse-transformed includes points generated by the gamut-plane intersection may be performed using a point-triangle-inclusion test which judges whether a triangle including points to be color-inverse-transformed includes points generated by the gamut-plane intersection.

The color inverse transformation process may be performed using linear interpolation in the triangle.

Coordinate values of the points to be color-inverse-transformed and color values of the respective vertexes of the triangle may be provided for the linear interpolation.

According to an aspect of the present invention, there is provided a method of correcting a source device color into a target device color, the method comprising obtaining an array of color points of a source device represented in a predetermined color space; obtaining an array of color points of a target device represented in the same color space; producing gamut descriptors of the source device and the target device; gamut-mapping the color point array of the source device into a color point array of the target device; and performing a color inverse transformation process to thereby calculate an RGB value for the gamut-mapped point arrays.

The predetermined color space may be an L*a*b* coordinate system.

The producing of the gamut descriptors may comprise reading an array of the points represented in the color space; reading a grid parameter in the color space; selecting a square forming the grid; dividing the square into two triangles; storing coordinates of the vertexes of each triangle; producing a unit vector (line) having a start point and a predetermined rotational angle; detecting intersection points between a set of the triangles and the unit vector; and detecting a point having the maximum chromaticity among the intersection points within a current gamut boundary in which the gamut intersected with planes arranged at predetermined angles.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become more apparent and more readily appreciated from the following description of the embodiments, taken in conjunction with the accompanying drawings in which:

FIG. 1 is a block diagram showing a color correction look-up table production scheme in which a color correction method according to the present invention is applied;

FIG. 2A shows an RGB color cube of a device dependent color space (DDCS);

FIG. 2B shows a gamut of RGB values which are obtained by transformation of the L*a*b* DICS (device independent color space);

FIG. 3 is a flow-chart view showing production of a CLUT (color look-up table);

FIG. 4A illustrates a gamut boundary in a two-dimensional lightness-chroma space;

FIG. 4B illustrates a result of intersection of the gamut boundary shown in FIG. 4A with planes;

FIG. 5A illustrates a subdivision of an RGB color cube in a set of triangles;

FIG. 5B illustrates a subdivision of a device gamut in a set of triangles.

FIG. 6 illustrates an intersection of a device gamut and a plane;

FIG. 7 illustrates positions of planes in an L*a*b* space;

FIG. 8A illustrates distribution of rays within a current plane in the L*a*b* space;

FIG. 8B illustrates points at which the rays shown in FIG. 8A intersect a boundary of the device gamut;

FIG. 9 illustrates an example of ray-triangle-inclusion;

FIGS. 10A and 10B are flow-charts illustrating a gamut descriptor production method;

FIG. 11 illustrates positions of rays for a ray-triangle-inclusion test;

FIGS. 12A, 12B and 12C are diagrams briefly explaining a gamut mapping routine;

FIGS. 13A, 13B and 13C are diagrams illustrating a gamut mapping direction;

FIGS. 14A and 14B are flow-charts illustrating an overall gamut mapping routine;

FIG. 15 illustrates the result of intersection of a plane and a structure, which represent a gamut and the results of Delaunay triangulation algorithms; and

FIGS. 16A and 16B are flow-charts illustrating a color inverse transformation process.

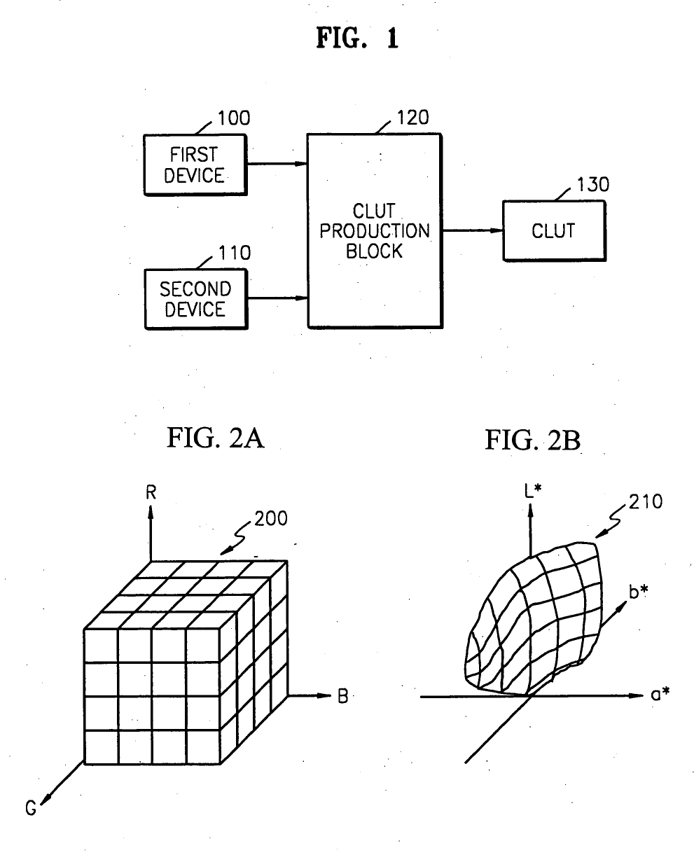

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The present invention provides a fast gamut mapping method. A purpose of the gamut mapping is to produce a color transformation look-up table (CLUT), which helps the color transformation process between different RGB device dependent color spaces (DDCSs).

A method of creating a CLUT according to the present invention is shown in FIG. 3. An L*a*b* data array is obtained by measuring second device color patches (operation 300). Separately, a first device point array is produced together with the same color values as printed color patches (operation 310). The first device points are transformed into data in an L*a*b* space (operation 320). Routines of producing gamut descriptors (operations 330 and 340) are methods for making a set of points representing surfaces of a gamut.

A gamut mapping routine (operation 350) provides rules for re-locating points from a first device color space into a printer color space, or a three-dimensional warping procedure. When the gamut mapping routine is finished, an array of gamut-mapped points is used for a color inverse transformation CLUT production routine (operation 360). The color inverse transformation CLUT production routine includes various operations such as a point detection operation in a three-dimensional space and a color interpolation operation in a three-dimensional space.

An initially important operation of gamut mapping is to produce gamut descriptors. A gamut descriptor is a set of gamut boundary points or signals carefully selected from a device independent color space (DICS). The present invention defines the gamut boundary using a set of points. All of the points in the gamut descriptors are positioned on a two-dimensional space forming a boundary. The two dimensions of the space consists of two axes, lightness and chroma.

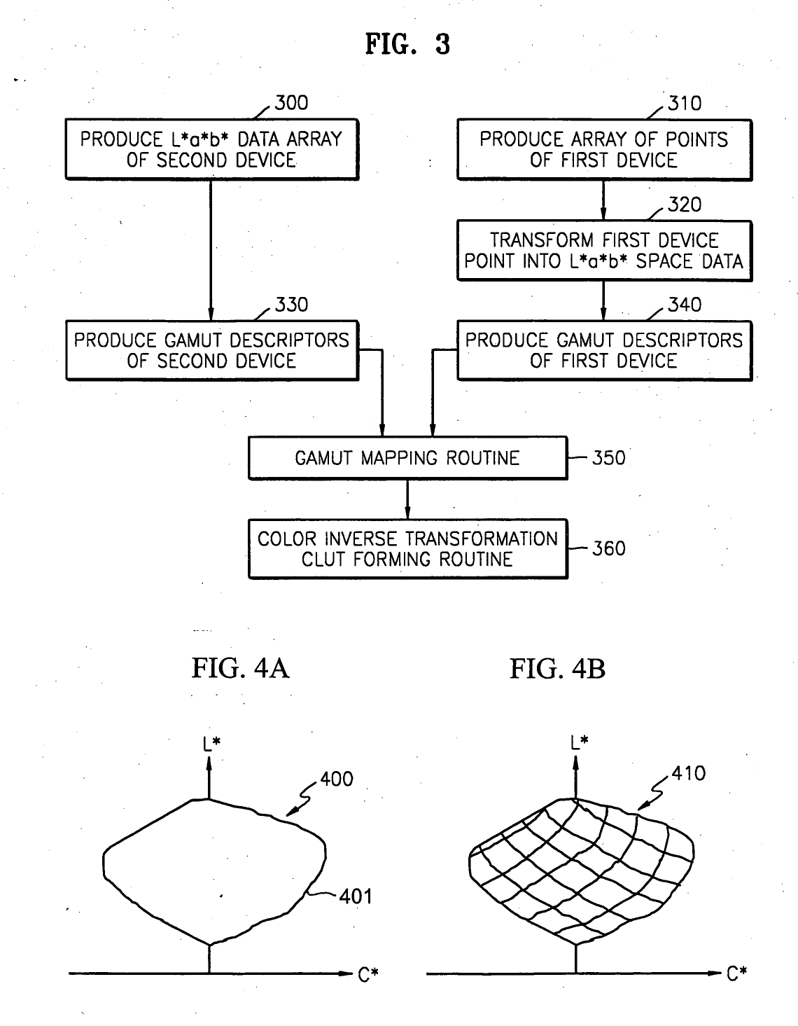

FIG. 4A illustrates a gamut boundary 400 in two-dimensional lightness-chroma space (L*-C*). The gamut boundary 400 may be defined by a result 410 of the intersection of the device gamut with planes, as shown in FIG. 4B. The planes will be described below. The gamut boundary 400 is a curved line, which describes the form of the gamut shape in the two-dimensional lightness-chroma space. The curved line 401 is producible by interpolation between several points. The points are obtained by intersecting the lattice structure of the gamut with a plane. The points may also be called gamut descriptors.

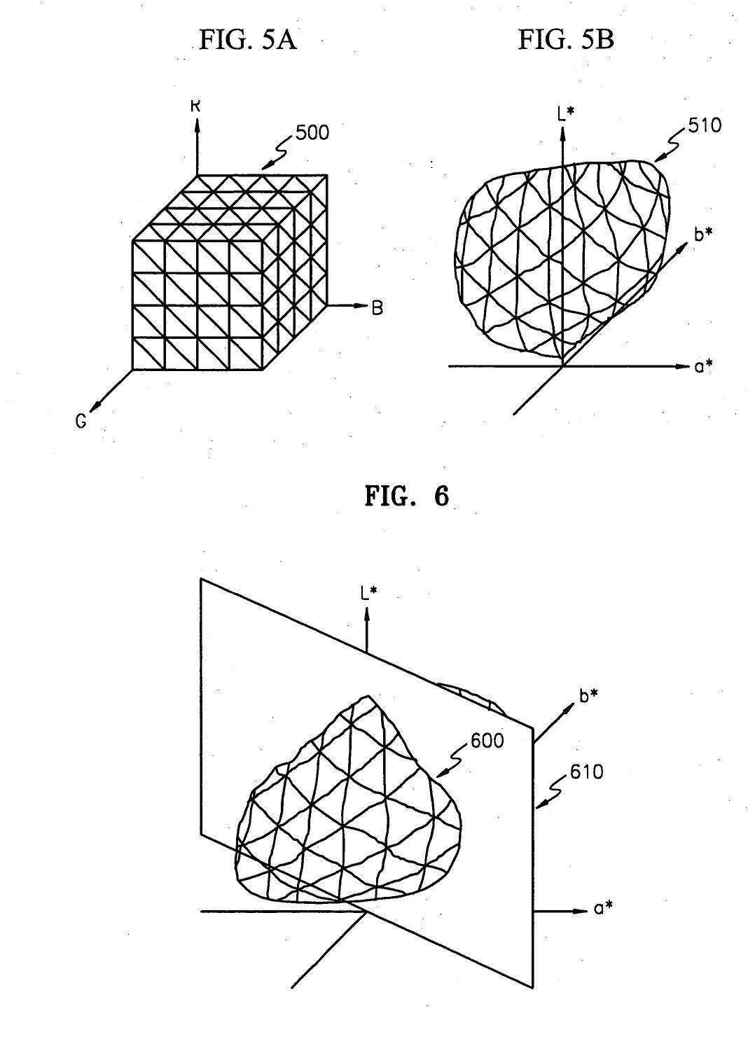

In the present invention, the gamut 200 of FIG. 2 is divided into a set of triangles. FIG. 5A illustrates a subdivision 500 of an RGB color cube (DDCS: Device Dependent Color Space) and FIG. 5B illustrates a subdivision 510 of a device gamut (DICS; Device Independent Color Space). The gamut descriptors are produced by intersecting the gamut with a plane. The gamut is represented with a set of triangles. FIG. 6 illustrates an intersection of a gamut 600 with a plane 610.

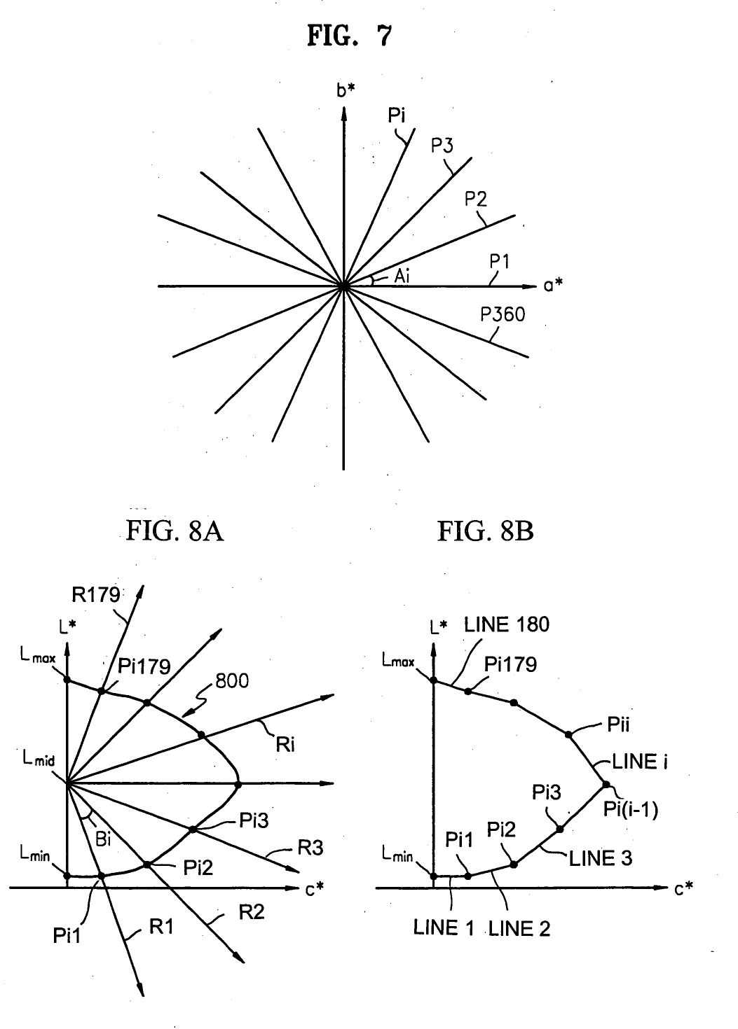

For a fast gamut mapping process, a number of gamut boundaries is limited to a predetermined number, and data values of the gamut descriptors are stored in a special order. The sequence of the gamut descriptors provides fast access to a single gamut descriptor. In the present invention, the gamut is divided three-hundred sixty (360) times by the planes. The planes rotate with respect to the lightness axis L*. FIG. 7 illustrates positions of the planes in the L*a*b* space. Ai denotes an angle between two planes, or a rotation angle for one plane. A general value of the angles is equal to one degree. P1, P2, P3, . . . Pi, . . . P360 denote planes and the number of planes is three-hundred sixty (360).

Then, a number of intersection points of each plane with a set of triangles of the gamut is determined. Since a number of the intersection points of each plane with a gamut is unlimited, the number of the points is limited to one-hundred eighty (180) for convenience. The number “180” is selected since a half circle is divided into 180 unit degrees. Each plane includes 180 rays. FIG. 8A illustrates distribution of 180 rays included in a current plane in the L*a*b* space. R1, R2, R3, . . . , and Ri denote rays having an identical start point L_{mid}, respectively. Bi denotes an angle corresponding to one degree. Pi1, Pi2, Pi3, . . . Pii denote intersection points between the gamut shape and a respective one of the rays. The intersection of the gamut shape with each plane is represented by intersection of the gamut shape with 180 rays. The number of the gamut descriptors for a whole gamut is 64,800 (=180*360).

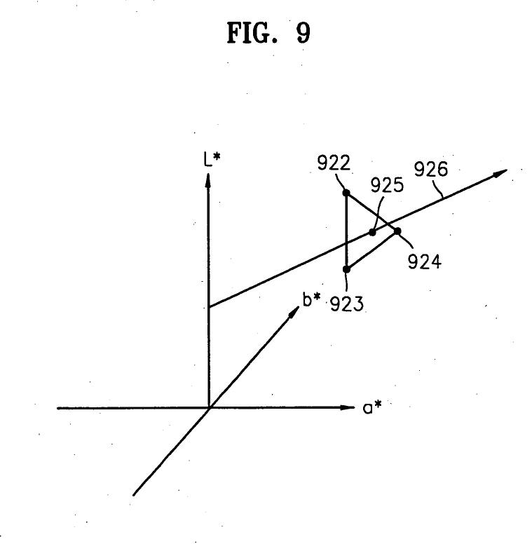

A gamut boundary 800 may be reproduced by connecting the intersection points with each other. Connections between points Lmin, Pi1, Pi2, . . . Pi(i-1) and points Pi1, Pi2, Pi3 . . . Pii, respectively, are represented by lines Line1, Line2, Line3, . . . Line(i-1), respectively. Since the gamut is subdivided into a set of triangles, the intersection point can be calculated by linear interpolation after completion of a ray-triangle-inclusion test. FIG. 9 illustrates an example of a ray-triangle-inclusion test. A piece of a gamut bounded by three points 922, 923, and 924 is intersected by a ray 926 at an intersection point 925.

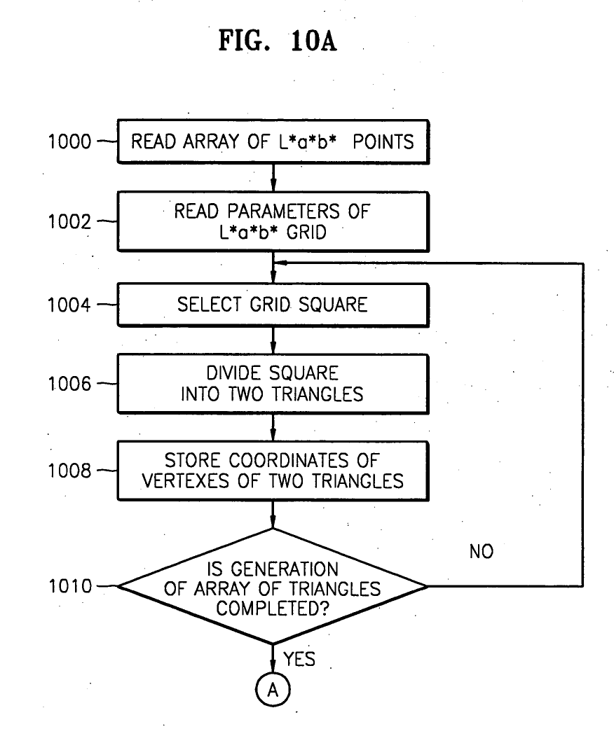

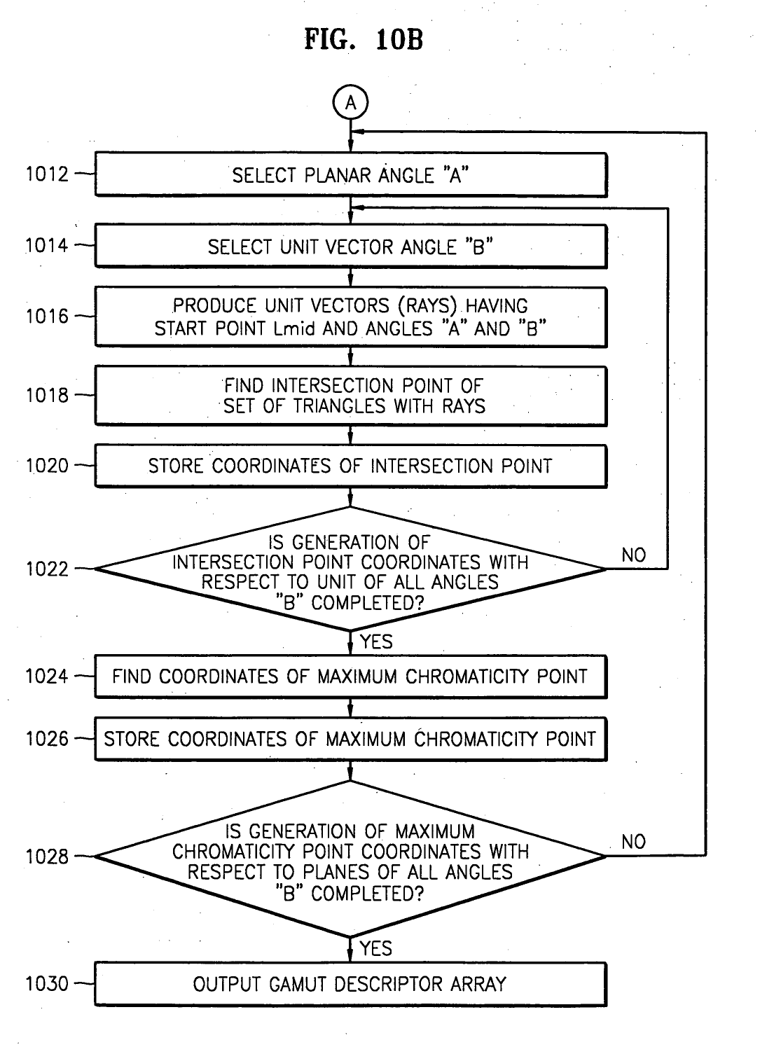

FIGS. 10A and 10B are flow-charts illustrating a gamut descriptor production method. An array of L*a*b* points is read (operation 100). The array of points is previously stored, for example, in a hard disc drive and represents the measured data or L*a*b* values converted from first device values.

Parameters of a lattice are provided (operation 1002). A general lattice structure is symmetrical. There are 3×3×3 points, 5×5×5 points, 9×9×9 points, 17×17×17 points or 33×33×33 points as common parameters with respect to a three-dimensional space.

A lattice square is selected (operation 1004). Each lattice square is divided into two triangles (operation 1006). Coordinates of each vertex of each triangle are stored in a special array for the purpose of quickly accessing a desired triangle (operation 1008).

A determination of whether generation of an array is completed is made (operation 1010). If production of the array has not been completed at operation 1010, operations 1004 through 1008 are repeated. If the determination is made in operation 1010 that production of the array has been completed, a planar angle A and an angle B between rays (or unit vectors) are selected in operations 1012 and 1014, respectively. Operations 1000 through 1014 produce a gamut boundary having the selected angles A and B. The angle A is determined to be one of degrees between 0 to 360 degrees with an angular displacement between adjacent planar angles A being equal to one degree. The angle B is determined to be one of degrees between 0 to 180 degrees.

The angle A may be calculated by using the following Equation 1.

$$A = {tan}^{- 1} ( \frac{{b}^{*} - {b}_{c}^{*}}{{a}^{*} - {a}_{c}^{*}} ) \qquad ( 3 )$$

Here, a* and b* are coordinates of the point for gamut mapping in an L*a*b* space, and a*_{c} and b*_{c} are symmetrical center coordinates in the L*a*b* space.

The angle B may be calculated by using the following Equation 2.

$$A = {tan}^{- 1} ( \frac{{L}^{*} - {L}_{c}^{*}}{{( {( {a}^{*} - {a}_{c}^{*} )}^{2} + {( {b}^{*} - {b}_{c}^{*} )}^{2} )}^{0.5}} ) \qquad ( 2 )$$

Here, L* is a coordinate of a point for gamut mapping in the L*a*b* space, and L*_{c} is a symmetrical center coordinate in the L*a*b* space.

A first cycle (operation 1012) rotates the ray in angle A. A second cycle (operation 1014) rotates the ray in angle B.

Unit vectors (rays) having a start point Lmid and direction angles A and B are produced (operation 1016).

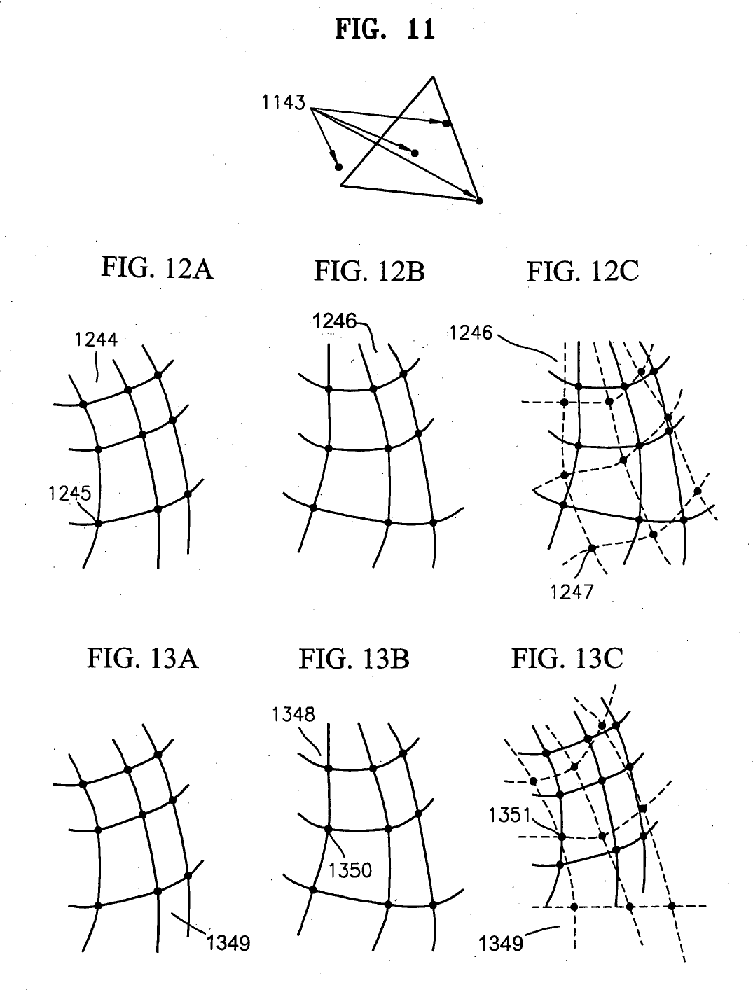

Coordinates of points are produced by interpolation with a triangle. A triangle search routine (operation 1018) comprises a ray-triangle-inclusion test. Intersection points of a set of triangles with rays are found (operation 1018). The coordinates of the intersection points are stored in operation 1020. It is common that transformation of the triangle coordinates into the barycentric coordinates is not convenient. In other words, it is not convenient to transform coordinates of a triangle from a reference system centered outside the triangle to a reference system centered on the center of gravity of the triangle. A search routine includes simply a ray-plane intersection test, a point-to-point direct inclusion test, and a ray-segment-inclusion test. FIG. 11 illustrates all positions 1143 of rays for a ray-triangle-inclusion test.

A gamut has a center of symmetry. The center of symmetry is illustrated as Lmid in FIG. 8A, and plays a role of a start point of 180 rays. The center of symmetry Lmid is assumed for the purposes of explaining the present invention. Actual calculation and determination of a center coordinate is complicated and will not be described herein since such calculation is not necessary for an understanding of the present invention.

Referring again to FIGS. 10A and 10B, it is checked whether coordinates of points for rays of angle B have been completely produced (operation 1022). If the coordinate production has been completed, operation 1024 is executed, and if the coordinate production has not been completed, angle B is shifted (operation 1014) and operations 1016 through 1020 are executed again.

In general, a gamut mapping routine requires coordinates of the points having the maximal chromaticity for a current gamut boundary. A series of search routines (operation 1024) are provided in order to find the maximal chromaticity points.

To simplify calculations, it is noted that a gamut boundary starts from a point having a minimal lightness denoted as Lmin in FIGS. 8A and 8B, and ends at a point having a maximal lightness denoted as Lmax in FIGS. 8A and 8B. The maximal chromaticity points are stored (operation 1026).

If it is determined that planar angle A has been completely rotated in operation 1028, an array of gamut descriptors is output (operation 1030). If it is determined that planar angle A has not been completely rotated in operation 1028, angle A is shifted in operation 1012, and then operations 1012 through 1026 are again executed.

As illustrated in FIG. 3, a gamut mapping routine operation 350 follows the gamut descriptor operations 330 and 340. Usually a gamut-mapping means the three-dimensional warping procedure. FIGS. 12A, 12B and 12C illustrate an example of the gamut mapping routine. The points in a source gamut space 1244 have a certain regularity, and are to be re-aligned into new positions in a reproduction gamut space 1246. The gamut mapping direction goes from the source gamut 1244 to the reproduction gamut 1246. The gamut mapping result becomes a new position 1247 of the point 1245.

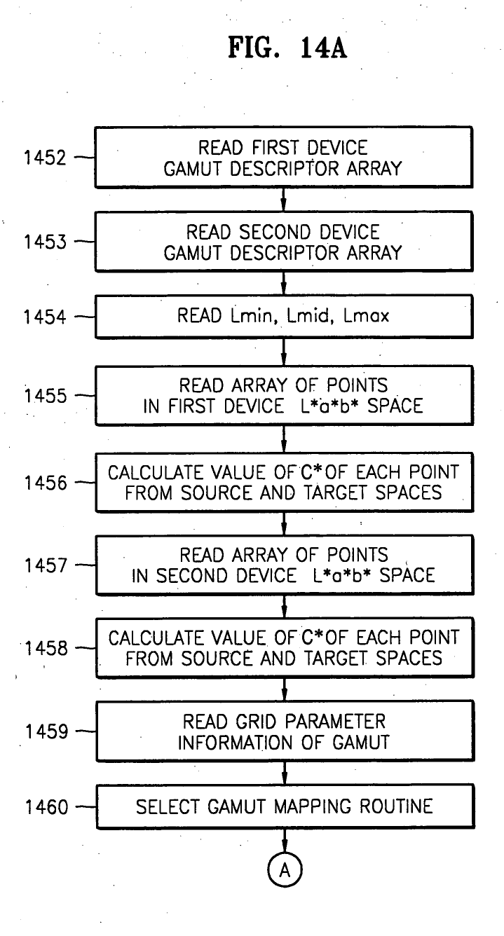

A major reason for selecting the mapping direction is because a size of the reproduction gamut differs from a size of the source gamut. The size of the source gamut is usually larger than the size of the reproduction gamut. The gamut mapping routine is used to reduce a difference between the source gamut and the reproduction gamut. It is appropriate to map a point of a smaller gamut into that of a larger gamut, in order not to lose information. In the present invention, a mapping direction varies. FIG. 13 illustrates a gamut mapping direction. A point 1350 in a reproduction gamut space 1348 is re-aligned in the direction of a source gamut space 1349. The gamut mapping result becomes a new position 1351 of the point 1350.

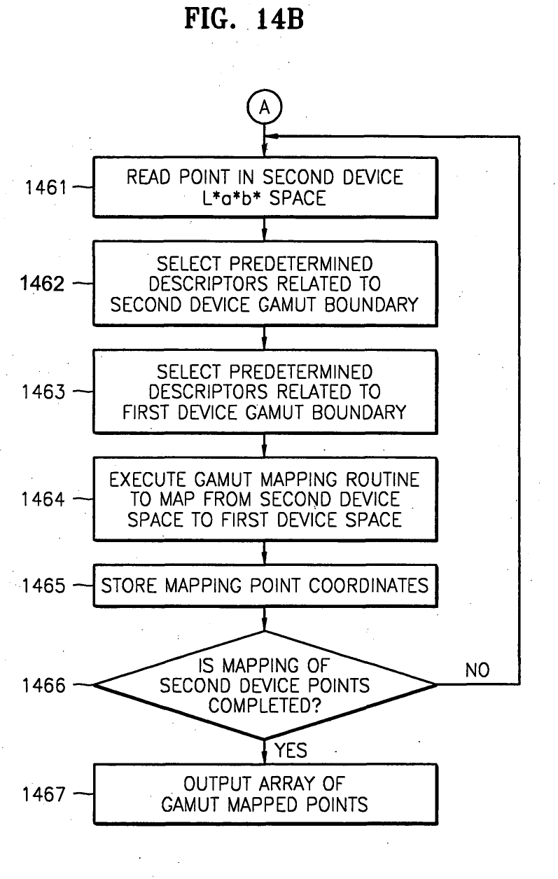

FIGS. 14A and 14B are flow-charts illustrating an overall gamut mapping routine. The gamut mapping routine reads an array of gamut descriptors of a first device and an array of gamut descriptors of a second device, obtained through the FIG. 12 gamut mapping routine (operations 1452 and 1453). Values of Lightness Lmin, Lmid, and Lmax are read (operation 1454). An array of points in an L*a*b* space of the first device is read (operation 1455).

A value of C* for each point from a source space and a target space is calculated (operation 1456). The calculation is performed using Equation 3.

C*=(a*a*+b*b*)^{0.5} (3)

An array of points in an L*a*b* space of a second device is read (operation 1457). A value of C* for each point from a source space and a target space is calculated using Equation 3 (operation 1458). Information with respect to the lattice or grid parameters for both gamuts are read (operation 1459). Ideally, both grids have identical parameters.

A gamut mapping routine is selected (operation 1460). Many well-known methods to provide a gamut mapping are known to exist, including, e.g., a SLIN method, a CUSP method, a GCUSP method, and a CARISMA method.

Points in an L*a*b* space of a second device are read (operation 1461). A predetermined number of descriptors, for example, 179 descriptors, related to the second device gamut boundary, are selected (operation 1462). A predetermined number of descriptors, for example, 179 descriptors, related to the first device gamut boundary, are selected (operation 1463).

The gamut mapping routine selected above is executed so that a point in a second device read from operation 1461 is mapped in a first device space (operation 1464). The coordinate of the point whose mapping has been executed is stored (operation 1465).

If it is determined that some points of the second device have not been completely mapped (operation 1466), operations 1461 through 1465 of reading other points of the second device and mapping the other points are repeated. If it is determined that all points of the second device have been completely mapped (operation 1466), an array of the gamut mapped points is output (operation 1467).

The present invention provides a color inverse transformation method as illustrated in operation 360 of FIG. 3. The color inverse transformation method includes a search routine and a color interpolation routine.

The search routine provides a process of detecting whether a given point is surrounded by a set of points. In general, a gamut color space is divided into a set of tetrahedrons. The search routine is executed by a point-in-tetrahedron-inclusion test. A set of tetrahedrons is produced by dividing each cube in the gamut. The cube can be divided into five or six tetrahedrons. The search routine provides the point-in-tetrahedron-inclusion test. The test detects whether there exists at least one point in the tetrahedron. A neighborhood determination of whether a point is surrounded by tetrahedrons becomes a condition for color interpolation. The color space can be divided by tetrahedrons, cubes, pyramids, or prisms. The present invention provides inverse transformation by using triangles. A set of triangles is made by the Delaunay triangulation algorithm. The method of the present invention can provide a gamut reproduction method suited to various situations. The main idea of the present invention relates to division of a structure, i. e., a gamut in a three-dimensional space, with planes.

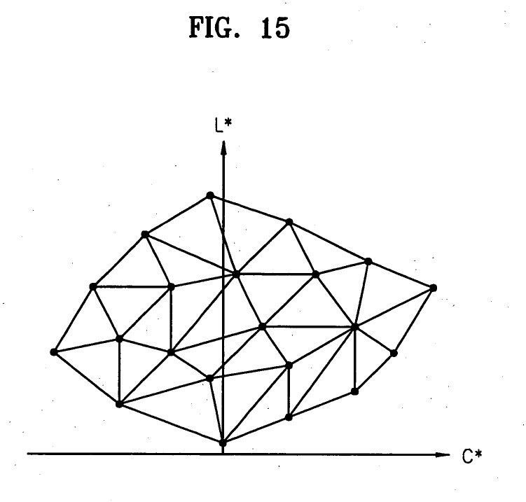

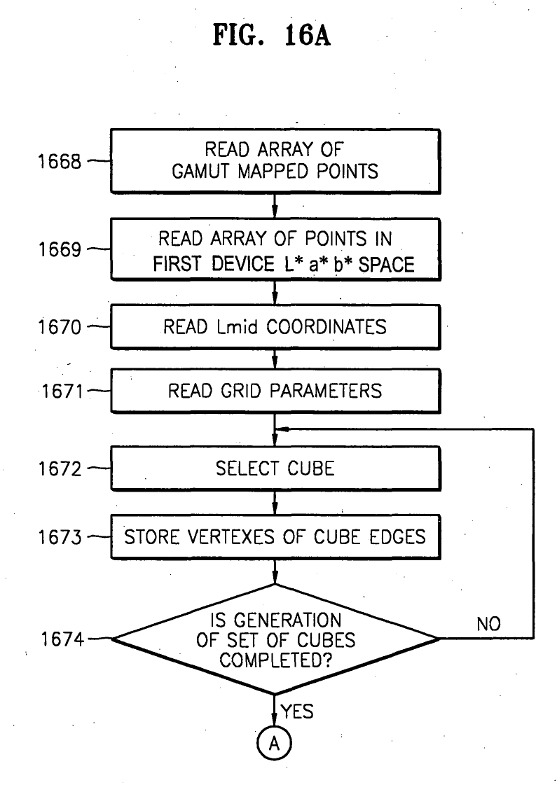

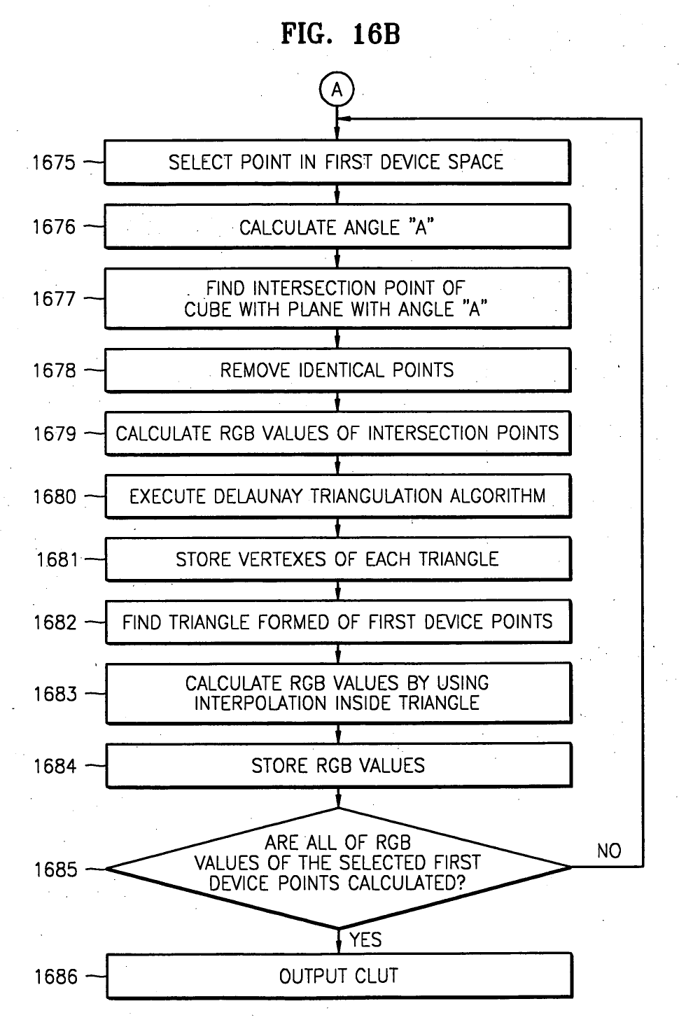

FIG. 15 illustrates results of an intersection between a plane and a structure, which represent the gamut and the result of the Delaunay triangulation algorithms. FIGS. 16A and 16B are flow-charts illustrating a color inverse transformation process.

First, an array of the gamut mapped points obtained through the whole gamut mapping routine shown in FIGS. 14A and 14B is read (operation 1668). An array of points in an L*a*b* space of a first device is read (operation 1669). A coordinate of lightness Lmid and a grid parameter are read in operations 1670 and 1671, respectively.

The transformation includes gamut division by means of a set of cubes or cubes. The cubes may be replaced by tetrahedrons, prisms or pyramids. In order to produce a set of cubes, operations 1672, 1673, and 1674 are executed. First, one cube is selected (operation 1672), and vertexes of the cube are stored (operation 1673).

It is determined whether generation of a set of cubes has been completed (operation 1674). If it is determined that generation of a set of cubes has not been completed (operation 1674), operations 1672 through 1673 are repeated. If it is determined that generation of a set of cubes has been completed (operation 1674), operation 1675 is executed.

The set of cubes is a geometrical description of the gamut. A point selected (operation 1675) in the first device space is a point to be processed for color interpolation.

A neighborhood detection process around the first device point is provided by a plane-gamut cutting process. The gamut is divided into two pieces by a plane. The plane is perpendicular to the plane defined by the a* and b* coordinates. The plane always intersects the lightness axis at two points, and intersects the first device point.

An angle A with respect to a first device point is calculated (operation 1676). Accordingly, parameters of the plane are defined. As a result of intersection of a set of cubes and a plane arranged at a corresponding angle, a set of points is produced (operation 1677). In the set of points, if some points are identical, all but one of the identical points may be removed (operation 1678).

The RGB values of an intersection point are produced by using a second device RGB grid (operation 1679). The color values for each intersection point are interpolated by using linear interpolation. Then, a triangle production operation 1680 is executed. A set of triangles may be produced by using the Delaunay triangulation algorithm and an intersection point.

The vertices of each triangle produced in operation 1680 are stored (operation 1681). Then, an operation 1682 of detecting a triangle formed of first device points is executed (operation 1682). The point-triangle-inclusion test is applied to the triangle and the first device point.

Finally, a color inverse transformation process is executed by using linear interpolation inside the triangle and the coordinate of the first device point (operation 1683). That is, RGB values are calculated. When RGB values are calculated by the color inverse transformation, the corresponding values are stored (operation 1684).

If the color inverse transformation process has been completed with respect to the selected first device points (operation 1685), a color look-up table (CLUT) is obtained with respect to the color inverse transformation (operation 1686).

As described above, the present invention can produce a color look-up table (CLUT) which provides a relationship between values in an RGB device dependent color space of a source color device and those in an RGB device dependent color space of a target color device.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of color correction, comprising:
selecting gamut boundary signals from a gamut in a device independent color space (DICS);
dividing the gamut into a set of triangles representing a gamut shape in the device independent color space (DICS);
intersecting the gamut with a first predetermined number of planes which are perpendicular to an a*b* two-dimensional space and intersect each other on an L* axis;
dividing each plane into a second predetermined number of radial unit vectors;
selecting each plane and each unit vector that are separated at a predetermined angle; and
determining an intersection point between a gamut boundary and each selected unit vector, by using a ray-triangle-inclusion test.

2. The method of claim 1, further comprising:
defining a gamut mapping direction according to sizes of a source gamut and a reproduction gamut, in which the gamut mapping direction proceeds from a gamut having a smaller size to a gamut having a larger size.

3. The method of claim 1, wherein the first predetermined number is 360.

4. The method of claim 1, wherein said second predetermined number is 180.

5. A method of color correction after gamut mapping, comprising:
regenerating a gamut shape in a device independent color space (DICS) into a predetermined structure represented in a three-dimensional space;
dividing the structure of the gamut shape represented in the three-dimensional space into planes;
connecting respective points in a set of points created by intersection of the gamut shape with the planes;
calculating a color value of each point;
determining whether a structure formed of points to be color-inverse-transformed includes points generated by the gamut-plane intersection; and
performing a color inverse transformation process by linear interpolation in the structure.

6. The method of claim 5, wherein:
the regenerated gamut shape is represented in the three-dimensional space by a set of tetrahedrons, cubes, pyramids, prisms, or lines.

7. The method of claim 5, wherein the connecting of the respective points comprises:
performing a Delaunay triangulation algorithm.

8. The method of claim 5, wherein the calculating of the color value comprises:
performing a linear interpolation between vertexes of the structure of the gamut shape represented in the three-dimensional space.

9. The color correction method of claim 5, wherein the determining of whether a structure includes points generated by the gamut-plane intersection comprises:
performing a point-triangle-inclusion test for determining whether a triangle including points to be color-inverse-transformed includes points generated by the gamut-plane intersection.

10. The color correction method of claim 9, wherein the performing of the color inverse transformation, comprises
performing a linear interpolation in the triangle.

11. The color correction method of claim 10, wherein the performing of the linear interpolation comprises:
providing coordinate values of the points to be color-inverse-transformed and color values of the respective vertexes of the triangle.

12. A method of correcting a source device color into a target device color, the method comprising:
obtaining an array of color points of a source device represented in a predetermined color space;
obtaining an array of color points of a target device represented in the same color space;
producing gamut descriptors of the source device and the target device;
gamut-mapping the color point array of the source device into that of the target device; and
performing a color inverse transformation process to thereby calculate an RGB value for the gamut-mapped point arrays.

13. The method of claim 12, wherein the predetermined color space is an L*a*b* coordinate system.

14. The color correction method of claim 12, wherein the producing of the gamut descriptors comprises:
reading an array of the points represented in the color space;
reading a grid parameter in the color space;
selecting a square forming the grid;
dividing the square into two triangles;
storing coordinates of the vertexes of each triangle;
producing a unit vector (line) having a start point and a predetermined rotational angle;
detecting intersection points between the two triangles and the unit vector; and
detecting points having the maximal chromaticity among the intersection points within a current gamut boundary, in which the gamut is divided into planes arranged at predetermined angles.
